(19) United States
(12) Patent Application Publication
(10) Pub. No.: US 2005/0225007 A1
(43) Pub. Date: Oct. 13, 2005

(54) Method and apparatus for rapid prototyping using computer-printer aided to object realization

(76) Inventors: Wei-Hsian Lai, Tainan City (TW); Chun-I Cheng, Jiading Township (TW); Sen-Yung Lee, Tainan City (TW); Muh-Rong Wang, Tainan City (TW); Chun-Shan Wang, Tainan City (TW); Chuh-Yung Chen, Tainan City (TW); Chieh-li Chen, Tainan City (TW); Chen Hsieh, Tainan City (TW); Sheng-Jye Hwang, Tainan City (TW); Cheng-Chien Wang, Rende Township (TW); Tzong-Shyng Leu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/093,078

(22) Filed: Mar. 30, 2005

(30) Foreign Application Priority Data
Apr. 8, 2004 (TW) 93118961

(51) Int. Cl. B29C 41/02

(52) U.S. Cl. 264/308; 425/375

(57) ABSTRACT

This invention applies a new computer and printer integrated technology to aid forming physical objects rapidly, and the method and apparatus are disclosed to satisfy the market requirements for a quick, reliable, safe, and inexpensive operation. The invention coverts a virtual object stored in the storage device of computer through software that slices the virtual object into many layers. The cross-section of the first layer is sent to a printer or a plotter, and the contour domain is printed or plotted by the printer or plotter. The fluid (not limited to binder) in the printer head is coated onto a layer of uniform distributed porous material which allows the powder and fluid to combine with each other; however, the combining process can be either a natural or an artificial process to enhance the binding force between the fluid and powder. After the first layer is finished, the second layer of powder is uniformly distributed on the first layer, and the contour printing process is repeated. As the printing process is repeated until all slicing layers of the model are finished, the object is stacked layer by layer sequentially. The physical object can be obtained after all the unglued powders are removed. The above-mentioned printing process not only produces monochrome objects, but also produces color objects. The machine includes components of a printer or plotter and its interface card, and x-z axis traversal driven mechanism. The operation platforms include a material supply chamber, a constructing chamber at which powder material is combined with solution, and a recycling hole. A slicing algorithm control software is used to calculate the cross-sectional contour, and the manufacture process is controlled by software and hardware interfaces.

### BACKGROUND OF THE INVENTION

1. Field of the Invention

The present invention relates to a method and an apparatus for a rapid prototyping, and more particularly to a method and an apparatus for a three-dimensional (3D) printing. The invention adopts a system integrating a computer and a printer or plotter and using a personal computer or workstation to solely develop a printer or plotter according to the market and functional requirements and produce a system that is comprised of an integrated printing platform with a planar moving function and then combined with devices and mechanisms having other functions, so as to produce an apparatus that creates a three-dimensional physical object according to a virtual object stored in a computer memory location. With the principle and technology of the three-dimensional prototyping method, a set of 3D rapid prototyping machine is developed successfully. The apparatus of the present invention is used to integrate the object slicing algorithm control software with the process control firmware of the object printing prototyping to stack, print and manufacture the physical object layer by layer according to the virtual object stored in a computer memory location by depositing the binder on a composite powder material at a selected position.

2. Description of the Related Art

In the past two decades, computer aided manufacturing (CAM) technologies advanced and the manufacture industry developed a rapid prototyping (RP) to create prototypes for designs in a very fast manner. The RP has no limitations on geometric shapes, and the more complicated the components, the more significant benefit from the performance of RP. RP can greatly save manufacturing labor and time. With the requirement of demonstrating components in a three-dimensional computer aided design (3D CAD) representation, the RP not only allows users to have a hand on the components, but also gives users an actual feel on the geometric curves of the components as well as allowing users to test the installation of components and even testing their feasible functions.

There are several kinds of rapid prototyping, such as 3D Printing, Stereo-Lithography (SLA), Selective Laser Sintering (SLS), Solider Process (SP), Fused Deposition Modeling (FDM), Laminated Object Manufacturing (LOM), and the so-called Office RP—Rapid Concept Modeler (RCM) which is the latest and most economic method. RCM quickly creates a prototype from the concept of a designer and integrally overcomes shortcomings and further creates a new mold after the user's confirmation to expedite productions. Such arrangement not only expedites the inspiration and development of finished goods, but also saves a substantial amount of development costs.

At present, a RCM process melts paraffin with a higher melting point in a furnace and produces mono-sized droplets by piezoelectric crystals during its injection. Then, the CAD/CAM technology is used to shape the desired product and convert a three-dimensional object into many horizontal laminates. The mono-sized droplets are coated on specified planes of the laminates layer by layer, and the stacked object of these laminates forms the final desired three-dimensional shape. However, the present technology can only use paraffin for the mold, and such paraffin mold is further used to make other molds. If we can directly form metal droplets on a predetermined mold, the manufacturing time and development costs can be reduced greatly. Based on Pratt & Whitney's experience on developing airplane engine components, RP not only can lower the cost to 1/10 of the original cost, but also can shorten the time for 70˜90%.

The materials used for RP can be divided into solid (such as LOM), liquid (such as SLA), half-solid half-liquid (such as FDM), or powder (such as SLS). In the applications of powder metallurgy technology, metal powders are the main raw materials, and many different kinds of metal powders can be mixed evenly and used for shaping, and a sintering process can be included to obtain a good industrial component. Many high-end aviation parts and automobile parts are made by this method. Of course, it is the first priority to have powders before using the powder metallurgy technology, and aluminum powder is the main raw material extensively used for chemicals, metallurgic products, military explosives, and rocket fuels. According to a report made by Taiwan's Chung-Shan Institute of Science and Technology, the use of powders in Taiwan increases gradually each year, and most of these powders are imported.

As to the original intention of RP, the RP regardless of being used for the conceptual design at an early development stage or for a prototype of a mold, the equipment invested in advance is a relatively expensive item. If it is possible to obtain a conceptual design in a more economic, more reliable, quicker and safer way, offices will be able to produce prototypes and the popularity of its application for future designs will be improved greatly.

Using a printing method to deposite onto porous materials to form a three-dimensional object had been disclosed in U.S. Pat. No. 5,204,055 in 1993, and Z Corporation further developed three-dimensional printers as described in U.S. Pat. Nos. 6,007,318 in 1999 and 6,375,874 in 2002 respectively. These patents provide the conceptual design for shaping equipments and the compositions of the powder materials and the binders. However, the composition disclosed in the patents is not operable with a commercial available printer-head because less amount of water injected around atmospheric pressure. Besides, the resolution of the printer-head is poor because the driving system is limited to an old fashion printer-head. The equipments of Z Corporation were also introduced in Taiwan around 2000, and the Department of Aeronautics and Astronautic of the National Cheng Kung University is one of the users. However, drawbacks are found in the machines and materials used after years of use. Therefore, an invention of a material was proposed in 2001, and the invention is still patent pending. Further, National Cheng Kung University together with a research and development group constituted by professors in the related field received the honor of academic science project award granted by the Ministry of Economic Affairs in December 2002 and a subsidy for a three-year research program, and thus a 3D printing core technology was researched and developed, after three-year efforts, and finally the method and apparatus of the 3D printing technology was implemented and recognized after an one and half year research and feasibility study.

### SUMMARY OF THE INVENTION

In view of the experience of using the rapid prototyping machines produced by Z Corporation and the drawbacks of these machines, the inventor of the present invention based on years of experience in the mechanical manufacture field to overcome the problems of the imprecision of machines, the rough surface of finished goods, the large dimensional errors, the poor strength of materials, the green part easily damaged by hand handling that requires post treatments, the short life of printing nozzle, the defects in the manufacture process caused by the damage of printing, the slow printing speed that can print only two pages per minute, and the high cost of the machines.

Therefore, it is a primary objective of the present invention to provide a method and an apparatus for rapid prototyping without setting a standpoint or imitate the original rapid prototyping method and apparatus. The invention aims at the research and development on the optimization of an advanced 3D shaping method and apparatus and bases on the principle of striving for perfection to make improvements for the method and apparatus. A number of failures were experience during the process, and thus deriving different concepts for the applications, which proves the importance of original thinking. After extensive researches and discussions, it is necessary to have a brand new concept for the design in order to give a total solution and the present invention proposes the following method:
1. Using a common printer and its control device as a part of the machine: The Z Corporation adopts a printer-head made by HP and solely develops its own control card for controlling the quantity of deposited binders because the powder needs a large portion of binders in its composition. Particularly for the shell of finished goods, it is necessary to add more binder to achieve the required strength. However, such arrangement only allows a resolution of 600 dpi for the inkjet head, and the resolution for previous inkjet head only achieved 300 dpi. Therefore, it is necessary to develop a method for forming a powder by a smaller quantity of binders to directly use a common printer and its control device as the parts of the machine (the present resolution is over 1400 dpi) and to break through the conventional process of controlling the printer, which were not achievable by Z Corporation.
2. Developing a finer, stronger and better formable powder: This issue relates to materials and thus will not be described here. The formable powder of a low binder quantity was invented during the testing of this machine, and the details are described in the R.O.C. Pat. Application No. 90100996.
3. Extending the life of nozzle: The life of the nozzle can be elongated to a certain extent if a common printer is adopted, but it is necessary to design an inkjet nozzle cleaning device at the same time to go with the operation of the original printer. It is necessary to overcome the issue of continuously supplying inks or blinders, and thus the present invention should include a continuous ink or binder supply mechanism.
4. Expediting the printing: the printing speed is at least 4˜8 pages per minute if a common printer is used. The overall printing speed can be expedited by separating the powdering mechanism and the printing mechanism into independent devices so as to save the time of moving a printer head in the non-printing area.
5. Reducing the high cost of the machine: It spends lots of manpower to the develop the nozzle control card and requires another computer to serve as a data and process transmission operating device in the machine, the overall machine architecture becomes more complicated. Since the machine increases the quantity of binders, therefore a pump and its related control are added to the machine. The price of a common printer directly used in the rapid prototyping machine according to the invention is very low, and thus substantially overcoming the cost issue.
6. Improving the precision of the machine: The present invention proposes other mechanical designs to make the stacking process of the rapid prototyping machine more precise to improve the dimensional precision of the product, or even reduce the geometric difference. For example, the material supply chamber, constructing chamber, and recycle hole are integrated as a whole in the design to enhance the rigidity and improve the precision of the machine and its products.

### BRIEF DESCRIPTION OF THE DRAWINGS

FIG. 1 is a view of an integrated rapid prototyping system of the invention;

FIG. 2 is a perspective view of a rapid prototyping machine of the invention;

FIG. 3 is a bottom view of an operating platform of a rapid prototyping apparatus of the invention;

FIG. 4 is an enlarged view of a section of a printing platform of the invention;

FIG. 5 is an enlarged view of a section of a powdering platform of the invention;

FIG. 6 is a flow chart of a rapid prototyping printing process of the invention;

FIG. 7 is a perspective view of a material supply chamber, a constructing chamber and a box chamber with recycle holes of the invention; and

FIG. 8 is a block diagram of a binder injection system with a non-pressure control under the printer driving control interface.

### DETAILED DESCRIPTION OF THE PREFERRED EMBODIMENT

The present invention uses a system that integrates a computer with a printer or a plotter to use a personal computer or a workstation to develop an independent printer or plotter according to market or functional requirements, which are integrated into a system comprised of a printing platform and a powder platform having a planar moving function, and further assembled with other functional devices and mechanisms to combine the object slicing algorithm control software and the process control firmware for the object printing shaping. The method of stacking, binding, and producing a physical monochrome or color object layer by layer according to a virtual object stored in a computer memory space by depositing a binder onto a composite powder material at a selected position, and this method is a novel three-dimensional printing method and technology.

The apparatus of the present invention comprises an operating platform, a powdering platform and a printing platform transversally suspending across a precision sliding track on both sides of the operating platform, a driving mechanism coupled with the aforementioned platforms, a continuous binder supply system and a software and firmware interface, a material supply chamber, a constructing chamber and an excessive material recycle hole are disposed along the long axial direction of the operating platform, a piston type slab capable of moving vertically up and down and being closely fitted around the periphery of the material supply chamber and the constructing chamber, and these slabs are called material supply slab and constructing slab respectively and can be controlled to move their positions as to provide the function of laying a layer of powder with a constant quantity, and both of the powdering platform and printing platform have the function of being combined and separated, and the invention saves the unnecessary moving distance and time in the non-printing area. The shaped powders are placed in the material supply chamber and appropriated compressed into a flat compressed form. The powdering platform and powdering roller are driven by an integration of electric control procedure, software and hardware interfaces to smoothly transfer the composite powders in the material supply chamber onto a constructing slab, and the extra powder materials are collected into the recycle hole for the recycle, and then an automatic shaping control function is enabled to drive the printing platform, continuous binder supply system and nozzle to print a first contour domain of the graphic data of a three-dimensional object after being processed by slicing and stored in the computer memory onto the composite powder corresponding to the contour domain of the graphic data on the constructing slab and then produce thin slabs with a sliced contour. After one page is printed and shaped, the constructing slab is lower to the next level and the material supply slab is raised. The powdering platform and the powdering rollers moves each sliced materials prepared in advance from the material supply chamber onto the constructing slab of the constructing chamber. The extra powder material is also returned to the recycle hole for the recycle. The printing and powdering procedures are repeated until a three-dimensional object is completely formed. Finally, the 3D object buried in the constructing chamber is lifted, and the non-binding powder is removed to obtain a physical 3D prototype. If a monochrome binder is used in the process, then a monochrome physical object will be obtained; and if a color binder is used, then a color physical object will be obtained. To improve the product quality of the object, a bake-drying or blow-drying device is added to reduce the time for drying the object.

In the apparatus of the present invention, a powdering roller is installed onto the powdering platform for progressively laying each layer of powder materials onto the constructing slab. The process transfers a layer of constructing material of the formed powders in the material supply chamber onto the constructing slab and returns the remained extra powders to the recycle hole and collected into the recycle chamber under the platform.

The nozzle coupled to the printing platform of this apparatus can adjust the planar movement of the whole operating platform along the XY axis, and a nozzle cleaning device and a binder supply system are installed on the printing platform. Aft least one binder cartridge is installed in the printer cartridge and the binder cartridge serves as a small container for storing the binder while the printer jet deposites binders. The binder cartridge is connected to a pipeline for supplying the binders required by the printing. The printer-head includes a plurality of nozzles, and the conventional printing technology can be used to achieve the printing effect, and a multiple-sectional adjustment controls the quantity of the binders for the formation. The sliced contour of the object can be printed selectively onto the formed powder to form the object. This method evenly deposits the binder onto the powder bed, so that the formed object can have a stronger strength and precision. In addition, the nozzle cleaning device includes a wiper mechanism situated at the moving path of the nozzle for wiping away the dirt composed of dusts, powder, and binders and accumulated at the exit of the nozzle. When the nozzle passes through the wiper, a cleaning solution can be injected to clean the wiper. To assure the uniformity of depositing a large quantity of binders onto a larger area of the sliced contour for the printing, a soft groove-shape component and driving mechanism can be added into the design of the housing of the nozzle cleaning device for covering the jet nozzle when the nozzle is not in use. This function helps preventing the nozzle from being clogged and extends the life of the nozzle greatly.

The binder may be transparent or contains some color dyes, and the binder is deposited from the nozzle onto a selected area of the powder bed in the constructing chamber so as to produce a monochrome physical object or a physical object having several composite colors. The color binders are deposited from the surface of the object to a certain depth only to show the color of the physical object.

The material supply chamber, constructing chamber and recycle hole use two long plastic slabs, three shorter slabs, and an even shorter slab. A ball knife is installed onto the shorter slabs for cutting a transversal cornered layering. Two rectangular holes with a cross-section of smooth circular corners are formed on the internal walls of the material supply chamber and the constructing chamber. A groove is disposed around the periphery of the material supply and constructing slabs and assembled with a soft silica gel washer forming a mechanism similar to a piston for being moved vertically up and down in a precise and smooth manner, and preventing the powder in the chamber from falling down through the seams. The recycle hole is formed by the plastic slabs built at the external wall of the shorter slabs protruded from two long plastic slabs and the shortest slab. This design combines the material supply chamber, the constructing chamber and the recycle hole as a whole structure. The invention can achieve a better stiffness and a better parallelism and perpendicularity between the two chambers and thus effectively improving the geometric tolerance.

As to the software and firmware, the present invention adopts a separate execution of a slicing software program and a driving firmware for controlling the formation. After the slicing software completes the preparation of the object arrangement and sets the parameters for the manufacture, the firmware interface of the computer window control takes over and performs detections for the rapid prototyping manufacture and manufacturing conditions. Such arrangement not only uses a convenient PC-based control, but also saves the additional circuit design and devices for manually controlling the press buttons, which can lower the cost of the machine and simplifies the operating procedure.

The characteristics of the structure and assembly of the foregoing devices and various novel components will be described in details, illustrated in the drawings, and specified in the patent claim, so that the method and apparatus of using a three-dimensional object data stored in a digital form in the memory of a computer and a 3D printing to produce a physical object.

Compared with the functions of the prior art, the method and apparatus for the rapid prototyping in accordance with the present invention are seemingly the same as those developed by the Z Corporation, since Z Corporation has obtained patents and thus needs not to take samples for analysis or base on the imitation. In fact, the method and apparatus disclosed in this invention are very different from those taught by the Z Corporation. To elaborate the originality and improvements of the present invention, the differences between the present invention and the patent issued to Z Corporation are listed below:

1. The present invention comprises a printer or a plotter solely developed according to market and functional requirements. A common printer or plotter developed by major international printer companies such as HP, Canon, Epson, and Lexmark, etc already has good stability for jet printing and good precision for printing. Unlike the printer or plotter produced by the Z Corporation that can be used for certain brands and for some low-resolution nozzle only, the applicability of famous branded printer or plotter is broader and the precision is superior to those designed by the Z Corporation.

2. Unlike Z Corporation's setting the powdering roller and printing mechanism on the same movable platform, the present invention has a separate printing platform and powdering platform. Furthermore, the present invention also has advantages over the Z Corporation's design by having a light-weighted printing platform and saving unnecessary moving distance for the non-printing area.

3. Unlike Z Corporation's printing equipment that requires an additional pump and values as the pressure control for a normal printing, the present invention simply use the common printing technology to achieve the printing effect.

4. Unlike the Z Corporation's printing method of depositing different quantity of binder on a shell area and a core area, the present invention evenly deposites the binder on the powder bed, so that the produced object can have better strength and precision.

5. Unlike the Z Corporation's pipe designed for collecting waste binder of the jet nozzle, the present invention has a soft groove-shape component and driving mechanism for covering and assessing the printing nozzle, which can prevent the jet from being clogged and greatly improve the life of the jet.

6. Unlike Z Corporation's manufacture process as depicted in FIG. 11 of U.S. Pat. No. 6,375,8745, the present invention has a design of integrating the material supply chamber, building chamber and recycle hole at a time, so that the present invention has a better stiffness, parallelism and perpendicularity, and thus effectively improving the geometric tolerance of the machine.

7. Unlike the software developed by the Z Corporation that requires another set of computer system for its use, the present invention executes the sliced layer software and the driver firmware for controlling the shaping and manufacture, so that the present invention not only has a more convenient PC based control, but also saves additional circuit design and device as well as lowering the cost of the machine and simplifying the operating procedures.

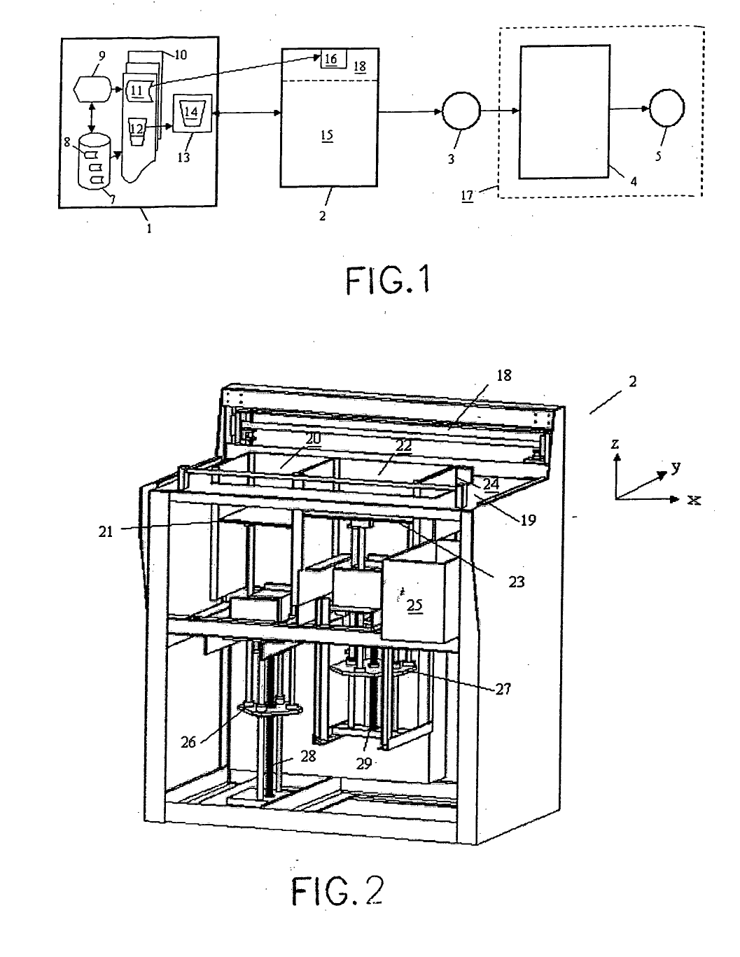

Referring to FIG. 1 for an integrated rapid prototyping system, the system comprises a computer 1, a rapid prototyping machine 2, a formed physical object 3, a post processing equipment 4 and a post processed physical object 5.

The computer 1 is a personal computer or a workstation, which can compute independently or through a local area network or a wideband network. The computer 1 includes some application programs 9 such as CAD/CAM software 9 for modifying the data of a three-dimensional object 8, and the data of the three-dimensional object 8 is assessed in a data access device 7 of the computer 1. If a user wants to produce post processed physical object 5, the user needs to output the data of the three-dimensional object 8 stored in the data access device 7 to the slicing software 10. After a series of sorting the three-dimensional object 8 and setting the corresponding manufacture conditions, the manufacture setup data 12 is sent to a Windows interface firmware driver program 13 and then to the rapid prototyping machine 2 through an interface card 14 of the Windows interface firmware driver program 13. The pre-powdering process is performed before producing the physical object 3, and the slicing software 10 drives the cleaning nozzle movement after the pre-powdering process is completed, and then the slicing algorithm result data 11 is sent to the rapid prototyping machine 2 for forming the physical object 3.

Rapid prototyping machine 2 is divided into a clean area 18 and a non-clean area 15, wherein the interface control circuit and electric components are disposed in the clean area 18. When the slicing software 10 sends the slicing algorithm result data 11 to a control circuit interface 16 of the rapid prototyping machine 2, the formation of the physical object 3 is performed at the rapid prototyping machine 2. The jet nozzle of a common printer or plotter is used to print a two-dimensional slice onto a laid powder bed, and the constructing slab 23 is lowered to a predetermined height of the layer thickness after a sheet is sprayed, and then the material supply slab 21 is raised. The powdering roller lays another new powder with a predetermined thickness onto the previous sheet of powder bed, and then the printing process for the second sheet is repeated. The process is repeated until the printing for the slicing algorithm result data 11 is completed, and then the binder and the formed powder are glued or reacted to obtain the physical object 3 from the formed result.

If the toughness of the physical object 3 meets user requirements, the post processing procedure 17 for improving the toughness of the physical object 3 can be omitted; if the toughness of the physical object 3 does not meet user requirements, the post processing equipment 3 is used for the processing until the physical object 5 is produced.

Referring to FIG. 2 for a perspective view of the rapid prototyping machine of the present invention, the machine comprises an operating platform 19, a material supply chamber 20, a piston type material supply slab 21 at the bottom, a constructing chamber 22 and a piston type constructing slab 23 at the bottom being disposed along an X-axis, a recycle hole 24 for collecting extra powder remained after powdering, and a detachable powder recycle collecting chamber 25. Although FIG. 2 omits the drawing of silica gel washer, each of the piston type material supply slab 21 and the piston type constructing slab 23 comes with a groove around their periphery, the soft silica gel washers are installed to give a close contact for the walls of the piston type material supply slab 21 and the piston type constructing slab 23 and form a mechanism similar to a sliding piston, which can prevent the powder in the chamber from falling down from the seam. The piston type material supply slab 21 and the piston type constructing slab 23 are connected to a H-shaped chassis 26, 27, and the H-shaped chassis 26, 27 constitute a precise linear movement with a screw rod transmission mechanism 28, 29 along the Z-axis of the material supply chamber 20 and the constructing chamber 22 respectively, such that the piston type material supply slab 21 and the piston type constructing slab 23 can move vertically up and down in a precise and smooth manner. With the powdering process, the required quantity of the constructing is supplied to the constructing physical object 3.

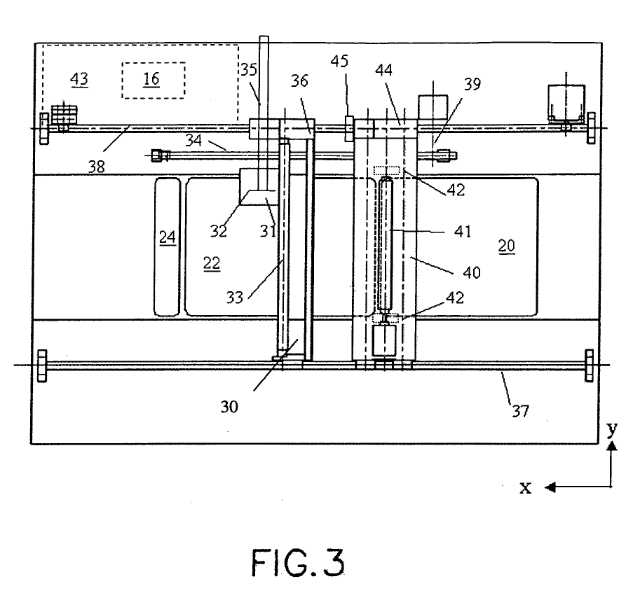

Referring to FIG. 3 for a bottom view of the equipments of the rapid prototyping machine 2 that removes the upper casings of the non-clean area 15 and the clean area 18, the operating platform 19 sequentially comprises a material supply chamber 20, a constructing chamber 22, and a recycle hole 24, a movable guide track 38 and a support guide track 37 disposed across the operating platform 19, a cantilever platform comprised of a printing platform 30, and a powdering platform 40, a movable guide track 38, and each guide track component module 36, 44 and axially rotated around the movable guide track 38. The support sliding track is suspended on the other side of the printing platform 30 and across the operating platform 19. A clutch rod 39 is moved vertically up and down during an operation period to engage a clutch guide track 34 with the printing platform 30, such that the printing platform 30 can intermittently move along the negative X-axis to control clutch guide track 34 and clutch device 45 to separate or combine the powdering platform 40 and the printing platform 30 to drive the movement and positioning of the powdering process back and forth along the X-axis. The printing platform 30 has a rapid sliding track 33 disposed along the y-axis for carrying at least one jet 31 and controlling the speed of the reciprocal movements along the axis of the rapid sliding track 33. In the printing period, the speed of the jet 31 along the Y-axis is larger than that of the printing platform 30 and the speed of the powdering platform along the X-axis. There are many small nozzle holes 32 aligned in at least one row on the jet 31 for controlling the binder solution to be sprayed at predetermined positions during the printing period. The binder solution is stored in a binder solution bottle and refilled into the jet 31 through a binder supply tube 35. The powdering platform 40 also has a powdering roller 41 and a powder shelter sliding plate 42, which will be described in details in a later section. In addition, an electric box 43 containing a control circuit board 16 and electric components in the clean area 18.

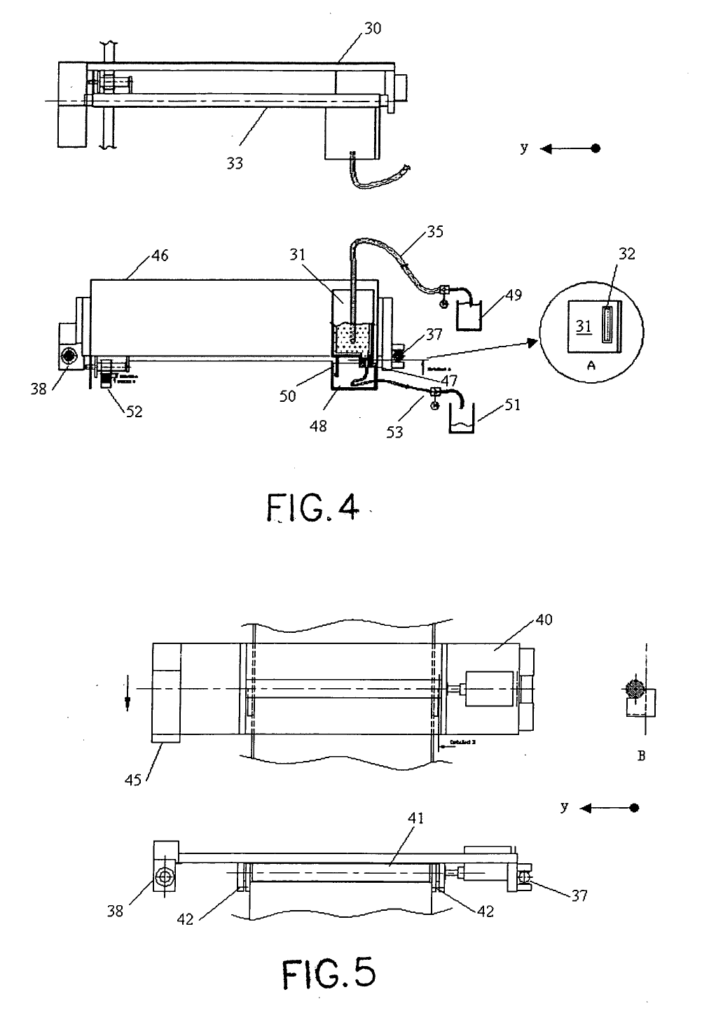

FIG. 4 is an enlarged view of a section of the printing platform 30 as depicted in FIG. 3. The printing platform 30 has a rapid sliding track 33 disposed on the Y-axis for carrying at least one jet 31 along the axis of the rapid sliding track 33 for controlling the speed for the reciprocal movements, and the jet 31 has many small nozzle holes 32 aligned in at least one row for controlling the binder solution to be sprayed at predetermined positions during the printing period. The binder solution stored in the binder solution storage bottle 49 is refilled into the jet 31 through the binder supply tube 35. A soft wiper 50 is installed on the moving path for wiping off the dirt accumulated at the jet 31 during the operating period, and the nozzle will spray a tiny amount of clean binder onto the soft wiper 50 at an appropriate time for cleaning the wiper as well as filling the binder into the small tube of the nozzle. The jet 31 includes a waste binder collecting cup 48 installed below the jet 31 for collecting the foregoing waste binder. When the nozzles of the jet 31 are cleaned, a cleaning device 47 installed below the nozzles is connected to a binder return tube 53 for returning the waste binder into a waste binder collecting barrel 51. A clutch frictional wheel 52 is connected to the clutch guiding track 34 to drive the printing platform 30 to move intermittently towards the negative X-axis during the printing period and separate the clutch guiding track 34 to move together with the powdering platform back and forth along the X-axis during the powdering period, and then engage with the clutch guiding track 34 for the positioning when the program returns to the origin. A sealed upper casing covers the printing platform 30 for isolating the dust in the non-clean area 15 to protect the drive circuit components and electric connectors of the jet 31.

FIG. 5 is an enlarged view of a section of the powdering platform 40 as depicted in FIG. 3. The powdering platform 40 has a powdering roller 41 and a powder shelter sliding plate 42. The powdering platform 40 moves along the X-axis during the powdering period to drive the powdering roller 41 to move just like a reverse milling way to move a layer of constructing material with a predetermined thickness of the formed powder in the material supply chamber 20 onto the constructing chamber slab 23. The extra powder remained after the process is returned to the recycle hole 24 and dropped into the recycle chamber 25. The powder shelter sliding plate 42 disposed on both sides of the roller are used primarily for preventing the extra constructing materials from leaking into the grooves of the operating platform from the edges of the material supply chamber 20 and the constructing chamber 22. The clutch device 45 as shown on the left side of FIG. 5, and its purpose is to pull the printing platform 30 back to the origin of the program when the powdering movement pushes the printing platform 30 to the utmost left and then moves to the right. As long as the program returns to its origin, the clutch device 45 is separated and the powdering platform 40 continues moving to the right and then to the utmost right position. A more detailed description of the printing process is given below.

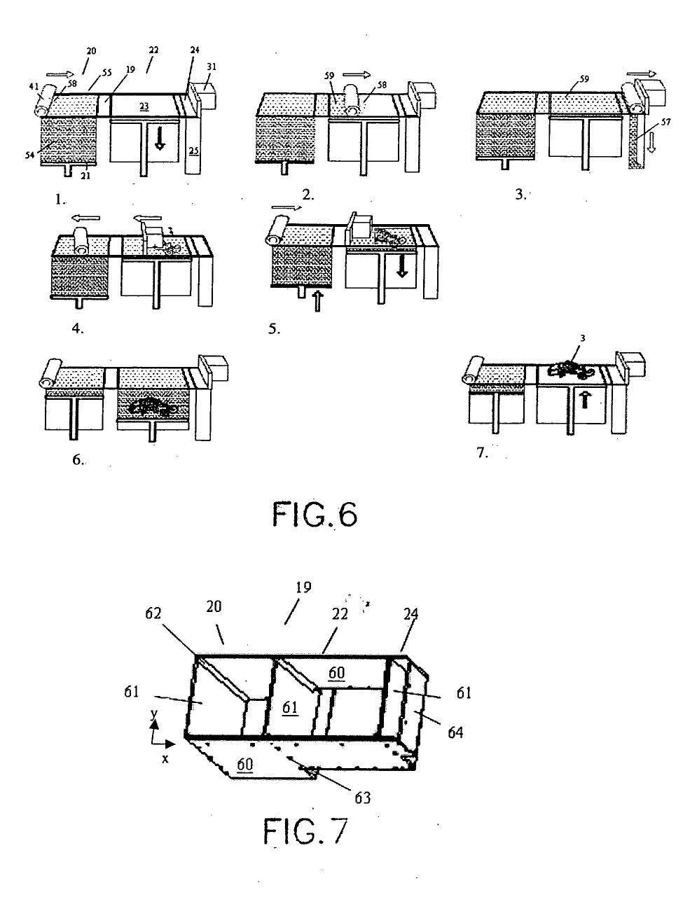

Referring to FIG. 6, a flow chart of the printing process of a rapid prototyping machine is illustrated.

1. Sufficient amount of constructing powder material 54 is poured into the material supply chamber 54 and the constructing powder material 54 is pressed appropriately, and then the constructing slab 23 is lowered to a distance equal to a predetermined thickness and the material supply slab 21 is raised to a height for supplying the required constructing powder material 55 to the constructing slab 23. The powdering roller 41 is rotated in a reverse milling way to wipe off the wavy powders of constructing powder material 58 from the material supply chamber 20.

2. The wiped constructing powder material 58 is transferred onto the constructing slab 23 of the evenly laid constructing powder material 59.

3. The remaining extra constructing powder material 57 is transferred to the recycle hole 24 and dropped into the recycle chamber 25. The material supply slab 21 and the constructing slab 23 are descended to a predetermined thickness, and the clutch device 45 of the powdering platform 40 is engaged with the printing platform 30 and pulled back to the origin of the program. If the printing platform 30 is moved to the origin of the program, the clutch rod 39 is driven up and down to move the clutch guiding track 34 to couple with the printing platform 30 and separate the clutch device 45. The powdering platform 40 continues moving to the right and returns to the utmost left position. By that time, the slicing software sends the slicing algorithm result data 11 to the printing control circuit interface 16 for carrying out the process of spraying binder onto an evenly laid constructing powder material 59 according to the contours of the sliced layer. The jet 31 linearly scans along the Y-axis to complete the printing of a row, and then the clutch frictional wheel 52 on the printing platform 30 couples with the clutch guiding track 34 to drive the printing platform 30 to move an increment along the negative X-axis. The jet 31 further moves along the Y-axis to linearly scan for the printing. After the second row is sprayed, the printing platform 30 further moves to the next increment along the negative X-axis, and such process repeats until a whole sheet is printed.

5. The constructing slab 23 is raised to a reserved distance equal to a predetermined thickness of the sliced layer, and the material supply slab 21 is raised to a height for supplying the required constructing powder material 55 to the constructing slab 23, and the powdering roller 41 is rotated according to a reverse milling way to wipe off the wavy constructing powder materials 58 from the material supply chamber 20, and the wiped constructing powder material 58 is transferred onto the constructing slab 23 of the evenly laid constructing powder material 59, and the printing platform 30 is pushed back to the utmost right position and then pulled and fixed to the position of the origin of the program.

6. Repeat Steps 1 to 5 as described above, until the physical object 3 is formed.

7. Lower the material supply slab 21 and raise the constructing slab 23. Remove the loose constructing powder which is not glued by the binder around the physical object 3 and take the physical object 3 out. Determine whether or not to process according to the specifications of the physical object 5.

Referring to FIG. 7 for a chamber box comprises of the material supply chamber, constructing chamber and recycle hole, the material supply chamber, constructing chamber and recycle hole use two long plastic slabs 60, three plastic shorter slabs 61, and an even shorter plastic slab 64.

A transversal cornered layering 61 cut by a spherical end of a ball knife is installed onto the shorter plastic slab 61 for. Two rectangular holes with a cross-section of smooth circular corners are formed on the internal walls of the material supply chamber 20 and the constructing chamber 22, and the recycle hole 24 does not come with smooth corners. A groove is disposed around the periphery of the material supply and constructing slabs 21, 23 and assembled with a soft silica gel washer forming a mechanism similar to a piston for being moved vertically up and down in a precise and smooth manner, and preventing the powder in the chamber from falling down through the seams. The recycle hole 24 is formed by the plastic slab wall on the external wall of the shorter slab 61 protruded from the constructing chamber 22 and the shortest plastic slab 64, and screws or nails are used for the connection. This design combines the material supply chamber 20, the constructing chamber 22 and the recycle hole 24 as a whole at a time. The invention can achieve a better stiffness and better parallelism and perpendicularity between the two chambers and thus effectively improving the geometric tolerance.

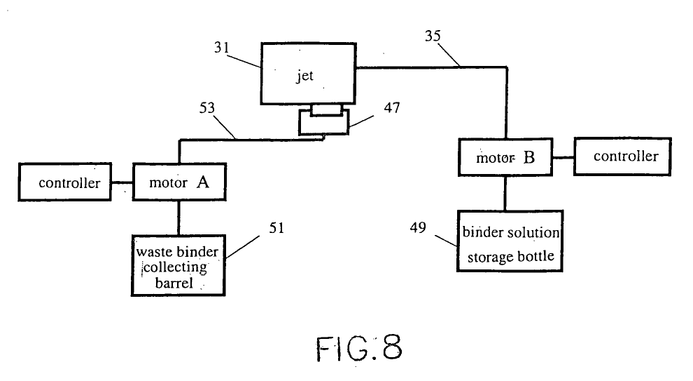

Referring to FIG. 8 for a block diagram of using a printer driver control circuit interface 16 to control an jet 31 of a binding system by a non-pressure control method, an jet cleaning device box 47 includes soft groove type components and a driving mechanism to seal the small nozzle holes 32 and provide a detachable movement as to continuously spray large quantity of binders onto a larger area according to the contours of the sliced layers for printer, prevent any dirt from clogging the small nozzle holes 32 and maintains the soft wiper 50 clean to maximize the wiping effect, improve the life of the jet 31, and prevent a low quality of the printing. If several successive sheets are sprayed according to contours with large area, a smooth continuous binder supply is a determining factor for a successful printing. In view of the foregoing factors, the present invention proposes a non-pressure control type jet binding system controlled by a printer driver interface to comply with the improvability and novelty.

The jet 31 has many small nozzle holes 32 aligned in at least one row for controlling the binder solution to be sprayed at predetermined positions during the printing period. The binder solution stored in the binder solution storage bottle 49 is refilled into the jet 31 through the binder supply tube 35 by means of a motor control binder supply mechanism (a motor B and a controller are shown in FIG. 8). A soft wiper 50 is installed on the moving path for wiping off the dirt accumulated at the jet 31 during the operating period, and the nozzle will return to the jet base. By then, a soft groove type component and a driving mechanism (motor A) are used to seal the small nozzle holes 32 and provide a detachable movement. A tiny amount of clean binder is drawn to the external side of the small nozzle holes 32, and the small nozzle holes 32 are rubbed back and forth against the wiper for cleaning the wiper as well as filling the binder into the small tube of the nozzle. The jet 31 includes a waste binder collecting cup 48 installed below the jet 31 for collecting the foregoing waste binder. When the nozzles of the jet 31 are cleaned, a cleaning device 47 installed below the nozzles 31 is connected to a tube for returning the waste binder into a waste binder collecting barrel 51.

The method for improving the rapid prototyping manufacture speed, strength, toughness and precision is divided into a pre-processing method and a post-processing method by the manufacture schedule according to the physical object 3 during the rapid prototyping process and after the rapid prototyping process respectively as described below.
1. Processing during the rapid prototyping process
A. Increasing the viscosity of the binder: It is applicable for standard to superior quality printing.
   B. Increasing the quantity of glued constructing material: It increases the binder quantity or repeats spraying binders.
   C. Entering external energies to promote the binding reaction:
a. Microwave or infrared is used for heating during the printing process.
   b. Hot air is introduced into the constructing area to expedite the drying and hardening.
   D. Controlling the manufacture parameters and conditions: The contraction ratio and the thickness permeability are corrected.
   E. Highly reactive binding action: single-dose or double-dose binding agent produces chemical bonds.
2. Processing after the rapid prototyped physical object 3 is formed:
   A. Being soaked by additional strengthened material: These materials include a quick-dry glue, a hard wax, or a resin.
   B. Surface Treatment: The surface treatments include sand blasting, mechanical vibration or ultrasonic vibration grinding, or spray paint.
   C. Entering external energies to promote gluing reaction:
   a. Microwave is used for heating the physical object 3.
   b. Infrared or oven is used for heating physical object 3.
   c. Chill and dry to facilitate the dehumidization of the material.
   d. Any two of the foregoing steps are combined to adjust the reaction of the physical properties.
   D. Jointly using a vacuum environment: The air in the object is vacuumed, and a special-purpose accelerant is soaked into the object to improve the permeated depth and maximize the properties.

For color printing, a printer cartridge with a 3D printing binder can be added into the color nozzle of a common color ink-jet printer for directly spraying and printing the color binder onto the constructing composite powder material 54 of a constructing slab 23 for a gluing formation. The color physical object 3 so produced can have broader applications. For example, product designers can directly stick the color textual and graphic labels of the product onto the surface of a 3D CAD object. The color 3D printing can directly produce a true color three-dimensional model from a 3D virtual image stored in a computer and rapidly provide product designer, business decision makers, manufacturers, and end users for further modifications and evaluations, so as to reduce wrong decisions and improve the quality of product design and market acceptance.

The binder may be transparent or include a color dye, and the foregoing binder can be deposited from the nozzle onto a selected area of the constructing powder bed to produce a monochrome of a composite color physical object. The slicing software can adjust the printing, so that only the surface of the object is sprayed with a coat of colored binder to a certain thickness so as to show the color physical object. The monochrome or colorless binder is sprayed onto the interior of the object. Since the cost of the color binder is higher than that of the monochrome binder, therefore the foregoing color adjustment and processing for the layers around the contours of sliced layers can speed up the printing and saves the quantity and cost of the binder.

1. A method and an apparatus for integrating a computer with a printer or a plotter for producing a physical object from a virtual object stored in a computer memory location, and said method and apparatus comprising:
an work area, having an operating platform with its length disposed along an x-axis and its width disposed along a y-axis, a material feed opening disposed along the direction of a long axis of said operating platform, a constructing hole, and a recycle hole for collecting extra materials; a material supply chamber, coupled to a material feed opening and a powder supply piston being movably contacted with the internal surface of said material supply chamber;
a constructing chamber, coupled to a constructing hole and a constructing piston being movably contacted with the internal surface of said constructing chamber;
a recycle chamber, coupled to a recycle hole for extracting and recycling extra materials remained after a powdering process;
a printing system, including a printing platform and a printing device transversally suspended above said operating platform, and said printing platform can move along the x-axis of said operating platform and said printing device includes a single printer-head or a plurality of printer-heads and its corresponding matrix nozzles, and said printer-heads can move along the y-axis of said operating platform for a printing process, said nozzles of said printer-heads can linearly scan the contour of each sliced layer at a selected position for depositing a binder on a smoothly and evenly laid constructing material;
a material laying system, having a material laying device movably and transversally suspended above said operating platform;
a continuous printing system, including an assembly comprised of at least one binder supply device, at least one printing device, and at least one nozzle cleaning;
a control device, disposed at a clean area and coupled to said constructing piston, said material supply piston, said transversally suspended powdering platform, said transversally suspended nozzle and jet for communications, and said control device can execute the instructions of:
controlling a process of transferring a material in said material supply chamber to said constructing chamber and progressively laying a constructing material on each sliced layer in sequence;
a control unit, for controlling a process of depositing a monochrome or a color binder from a monochrome or a color jet, and controlling the quantity of a binder to be sprayed onto a selected position of said each constructing layer, and integrally forming a contour domain on said each constructing layer according to a cross-sectional contour of a virtual object stored in a computer memory location;
capable of detecting, alerting, and handling an abnormal operation of said system;
a mechanism or a method for improving the quality of produced objects;
a set of object slicing algorithm control software;
a set of process control firmware for printing and prototyping objects.

2. The method and an apparatus for integrating a computer with a printer or a plotter for producing a physical object from a virtual object stored in a computer memory location of claim 1, wherein said system of integrating a computer with a printer or a plotter refers to using a personal compute or a workstation to solely develop a printer or a plotter according to market or functional requirements and a system comprised of a printing platform having a function of moving along a plane;
said apparatus of said system of integrating a computer with a printer or a plotter refers to an assembly comprised of a computer, a printer or a plotter and other devices and mechanisms to form an apparatus for producing a three-dimensional physical object according to said virtual object stored in said computer memory location;
said method of said system of integrating a computer with a printer or a plotter refers to a method of using said apparatus to combine said object slicing algorithm control software and control process firmware for printing and prototyping said object and producing a physical object by depositing said binder at a predetermined position of said composite powder material layer by layer according to said virtual object stored in said computer memory location.

3. The method and an apparatus for integrating a computer with a printer or a plotter for producing a physical object from a virtual object stored in a computer memory location of claim 1, wherein
said material feed chamber refers to an open chamber formed by connecting a material supply slab to a material supply chamber for storing said constructing materials required for prototyping said object;
said constructing chamber refers to an open chamber formed by connecting a constructing slab with a constructing chamber for accommodating said constructing materials required for constructing the thickness of said each sliced layer of said prototype transferred from said material supply chamber;
said recycle chamber refers to a chamber for accommodating said constructing material remained after laying on said constructing chamber for said constructing material transferred from said material supply chamber;
said material laying device refers to a transversally suspended powdering platform comprising an independent device or a device coupled with said printing platform, and said device includes powdering roller movable and transversally disposed across said powdering platform for supplying constructing material required for forming each slice layer of said object in sequence and transferred to said constructing chamber and said recycle hole;
a cleaning device, being movably contacted with a cylindrical surface of said powdering roller along the axial direction of said powdering roller for cleaning matters attached on said powdering roller; another cleaning device being movably contacted with the external wall of said material supply chamber along a y-axis, the external wall of said constructing chamber and the external wall of said recycle hole for transferring some of said constructing material from said material supply chamber to said recycle hole through said constructing chamber;
said binder supplying device refers to at least one container for storing said binder solution and being coupled to a pipeline and a binder supply control mechanism for supplying a binder solution into said printer-head, such that if the quantity of said binder in a printer cartridge is used for a certain amount, said binder supply device will supply said binder to maintain a continual printing process;
said printing device refers to a device for selectively depositing a monochrome or a color binder, and includes a nozzle of said printer-head moving back and forth along the y-axis of said constructing chamber according to the contour of said each sliced layer and controlling the position and binder quantity of said printing onto said constructing material to form the contour of said each sliced layer of said object;
said nozzle cleaning module and binding system includes a nozzle cleaning mechanism;
said monochrome or color binder is a sensible monochrome or color formed by one or more dyes dissolved, scattering, or suspended in said binder solution.

4. The method and an apparatus for integrating a computer with a printer or a plotter for producing a physical object from a virtual object stored in a computer memory location of claim 1, wherein said constructing material includes a powder material capable of acting on said binder to physically bind said powder without chemically reacting with said powder.

5. The method and an apparatus for integrating a computer with a printer or a plotter for producing a physical object from a virtual object stored in a computer memory location of claim 1, wherein said independent or multiple printer-heads refer to the number of channels for supplying said binders into said printer-head, and said each printer-head has a corresponding matrix nozzle.

6. The method and an apparatus for integrating a computer with a printer or a plotter for producing a physical object from a virtual object stored in a computer memory location of claim 1, wherein said control device controls said each nozzle of said printer-head to supply a predetermined quantity of said binder to be deposited on said each constructing material according to said linearly scanned contours of said sliced layer of said object and timely detects an abnormal operation of said printing process.

7. The method and an apparatus for integrating a computer with a printer or a plotter for producing a physical object from a virtual object stored in a computer memory location of claim 1, wherein said nozzle cleaning module is provided for removing any binder remained on said nozzle or any constructing material attached on said nozzle.

8. The method and an apparatus for integrating a computer with a printer or a plotter for producing a physical object from a virtual object stored in a computer memory location of claim 1, wherein said visible colors include three primary colors, five separated colors, and a black color of the ink used by different brands of printers.

9. The method and an apparatus for integrating a computer with a printer or a plotter for producing a physical object from a virtual object stored in a computer memory location of claim 1, wherein said selected position refers to the position for depositing said binder in a range according to said contour of said each sliced layer of said object.

10. The method and an apparatus for integrating a computer with a printer or a plotter for producing a physical object from a virtual object stored in a computer memory location of claim 1, wherein said binder supply device is operated with a intermittent supply or a continuous supply, and adopts the principle of a negative-pressure siphon, a positive-pressure intermittent compression, a continuous compression, or an intermittent compression for supplying said binder.

11. The method and an apparatus for integrating a computer with a printer or a plotter for producing a physical object from a virtual object stored in a computer memory location of claim 1, wherein said printing platform and said material laying device comprise an integrated device for jointly or separately executing said printing and laying constructing materials.

12. The method and an apparatus for integrating a computer with a printer or a plotter for producing a physical object from a virtual object stored in a computer memory location of claim 1, wherein said mechanism or method for improving the quality of produced object refers to a method of adjusting and controlling manufacture parameters of a machine or a method of adding other mechanisms for post processing to improve the quality of a produced object, after producing a physical object by a rapid prototyping process and a green part of rapid prototyping; and
said improved quality of produced object refers to improving the manufacture speed, strength, firmness, surface toughness, and geometric and dimensional precisions during the manufacture period for said prototyping process.

13. The method and an apparatus for integrating a computer with a printer or a plotter for producing a physical object from a virtual object stored in a computer memory location of claim 1, wherein said set of object slicing algorithm control software refers to a slicing algorithm control software coded by a program language and having a function of processing said 3D virtual object stored in said computer memory location into contour graphic data for said each sliced layer by a slicing algorithm and sending said data to a rapid prototyping machine to produce a 3D physical object required by said slicing algorithm control software.

14. The method and an apparatus for integrating a computer with a printer or a plotter for producing a physical object from a virtual object stored in a computer memory location of claim 1, wherein said set of process control firmware for printing and prototyping objects refers to an integrated interface control card, a hardware circuit and a drive sensor coded in a high-level or a low-level program language for making said process control firmware for physical printing and prototyping.

15. The method and an apparatus for integrating a computer with a printer or a plotter for producing a physical object from a virtual object stored in a computer memory location of claim 3, wherein said binder solution acts on said powder material or only attaches said powder without being reacted with said powder.

16. The method and an apparatus for integrating a computer with a printer or a plotter for producing a physical object from a virtual object stored in a computer memory location of claim 3, wherein said cleaning device is a movable device for preventing remained constructing materials from being scattered and accumulated around a material supply area and a constructing area.

17. The method and an apparatus for integrating a computer with a printer or a plotter for producing a physical object from a virtual object stored in a computer memory location of claim 5, wherein said binder is a colorless binder or a binder added with a color dye to be sprayed on said each constructing material in said constructing chamber at a position linearly scanned from said contour of said object sliced layer and the quantity of said binder can be controlled.

18. The method and an apparatus for integrating a computer with a printer or a plotter for producing a physical object from a virtual object stored in a computer memory location of claim 6, wherein said printer-head is a printer-head for a printer and a plotter available from a market, and its operating and driving methods include a piezoelectric vibration method, an air bubble compression method, and a pressure control driving method, and said printer-head nozzle moves back and forth along an X-axis of said constructing chamber to select the position and quantity of depositing said binder according to said contour of said each sliced layer and printing on said constructing material.

19. The method and an apparatus for integrating a computer with a printer or a plotter for producing a physical object from a virtual object stored in a computer memory location of claim 7, wherein said wiper cleans said binder remained at said cleaning nozzle, and a cup made of a soft material is provided for insolating air and keeping said nozzle wet when said nozzle is idled to prevent said nozzle from being clogged; a mechanism working together with said nozzle to drive said soft wiper and cup when said nozzle moves into said nozzle cleaning module so as to pass a dry clean binder into at least one nozzle and provide functions of cleaning and protecting said nozzle.
